(19) United States
(12) Patent Application Publication
(10) Pub. No.: US 2014/0317391 A1
(43) Pub. Date: Oct. 23, 2014

(54) METHOD FOR CHANGING A SYSTEM PROGRAM AND PROCESSING DEVICE UTILIZING THE SAME

(71) Applicant: NUVOTON TECHNOLOGY CORPORATION, HSINCHU SCIENCE PARK (TW)

(72) Inventor: Yuan Chuan YU, Hsinchu City (TW)

(73) Assignee: NUVOTON TECHNOLOGY CORPORATION, HSINCHU SCIENCE PARK (TW)

(21) Appl. No.: 14/195,206

(22) Filed: Mar. 3, 2014

(30) Foreign Application Priority Data
Apr. 19, 2013 (TW) 102113896

(51) Int. Cl. G06F 9/44; G06F 12/02

(52) U.S. Cl. CPC G06F 9/441; G06F 12/02
USPC 713/2

(57) ABSTRACT

A processing device includes a program memory and a processor. The program memory includes at least a first memory partition for storing a system program and a second memory partition for storing an application program. The processor is coupled to the program memory for executing the programs stored in the program memory. The processor executes the application program to enable the processing device to provide at least a predetermined function, and executes the system program to enable the processing device to update the application program. When the system program has to be changed, the processor further receives a first program from a host, stores the first program in the second memory partition, triggers a reboot procedure to reboot from the second memory partition and thereafter execute the first program to change the system program based on the first program.

### CROSS REFERENCE TO RELATED APPLICATIONS

This application claims priority of Taiwan Patent Application No. 102113896, filed on Apr. 19, 2013, the entirety of which is incorporated by reference herein.

### BACKGROUND OF THE INVENTION

1. Field of the Invention

The invention relates to a processing device and a method for changing system program of the processing device, and more particularly to a processing device capable of directly changing the system program and a method for directly changing the system program of the processing device.

2. Description of the Related Art

A Single-Chip Microcomputer, which is also called a Microcontroller or a Micro Processing Unit (MCU), is a microcomputer which integrates a central processing unit, a memory device, a timer/counter and a variety of input/output (I/O) interfaces in an integrated circuit chip. Compared to the general-purpose microprocessor utilized in a personal computer, the microcontroller is a low-cost device that does not require external hardware devices. The greatest advantage of the microcontroller is that it is small in size. However, the microcontroller has some disadvantages, such as having only a small amount of storage space, simple I/O interface, and low-level functionality.

Generally, the functions to be executed or performed by the microcontroller are defined by the internal programs. These programs are pre-programmed in advance, and stored in the internal memory device of the microcontroller. Therefore, the user may develop different programs based on different requirements, such that the microcontroller can execute or perform the required functions.

However, burning the program codes is usually done when the microcontroller chips are being manufactured in the factory. Thereafter, the user can directly solder the microcontroller chips in the corresponding circuits. In other words, when the program codes of the microcontroller have to be updated or changed to implement different functionalities, desoldering of the microcontroller chip from the circuit is required, costing time and money.

### BRIEF SUMMARY OF THE INVENTION

Methods for changing a system program and processing devices are provided. An exemplary embodiment of a processing device comprises a program memory and a processor. The program memory includes at least a first memory partition for storing a system program and a second memory partition for storing an application program. The processor is coupled to the program memory for executing the programs stored in the program memory. The processor executes the application program to enable the processing device to provide at least a predetermined function, and executes the system program to enable the processing device to update the application program. When the system program has to be changed, the processor further receives a first program from a host, stores the first program in the second memory partition, triggers a reboot procedure to reboot from the second memory partition and thereafter executes the first program to change the system program based on the first program.

An exemplary embodiment of a method for changing a system program, executed by a processor of a processing device for changing the system program stored in a first memory partition of a memory device of the processing device, wherein the processing device provides at least a predetermined function by executing an application program stored in a second memory partition of the memory device and the processing device updates the application program by executing the system program. The method includes: receiving a first program from a host; storing the first program in the second memory partition of the memory device; triggering a reboot procedure to reboot from the second memory partition; and thereafter executing the first program to change the system program based on the first program, wherein the processor is allowed to program the first memory partition of the memory device by executing the first program.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of a processing device according to an embodiment of the invention;

FIG. 2 shows a flow chart of a method for changing a system program according to a first embodiment of the invention;

FIG. 3 shows a flow chart of another method for changing a system program according to a first embodiment of the invention;

FIG. 4 shows a flow chart of a method for changing a system program according to a second embodiment of the invention; and

FIG. 5 shows a flow chart of another method for changing a system program according to a second embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

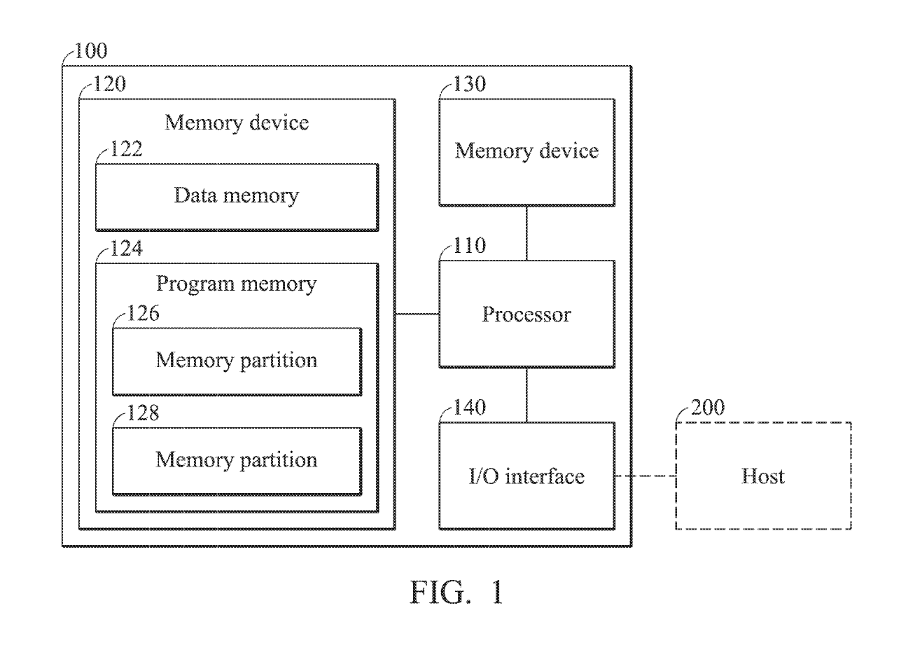

FIG. 1 is a block diagram of a processing device according to an embodiment of the invention. According to an embodiment of the invention, the processing device 100 may be a Single-Chip Microcomputer, a Micro Controller Unit (MCU) or a Micro Processing Unit (MPU). The processing device 100 may comprise a processor 110, memory devices 120 and 130 and an I/O interface 140. The processor 110 may be a central processing unit. The memory device 120 may further comprise a data memory 122 and a program memory 124. The data memory 122 stores data and the program memory 124 stores programs to be executed by the processor 110.

The program memory 124 may be partitioned into at least memory partitions 126 and 128. According to an embodiment of the invention, the memory partition 126 (also called the first memory partition) may be a system program memory partition for storing a system program and the memory partition 128 (or called the second memory partition) may be an application program memory partition for storing an application program. The processor 110 executes the application program to enable the processing device 100 to operate in a way defined by the application program and to provide a predetermined function.

The memory device 130 may be utilized to store the hardware setting values of the system, such that once the processing device 100 is powered up (that is, booting), the processor 110 may determine how to execute the subsequent procedures according to the hardware setting values. For example, when the processing device 100 is powered up, the processor 110 may determine whether to execute the program stored in the memory partition 126 first or to execute the program stored in the memory partition 128 first according to the hardware setting values.

The I/O interface 140 may comprise a plurality of different communication interfaces, such as General Purpose I/O (GPIO), Universal Asynchronous Receiver/Transmitter (UART), Inter-Integrated Circuit (I²C), or others. Generally, an external host 200 (drawn by dotted lines) may connect to the processing device 100 via the I/O interface 140 and also transmit or receive signals and data via the I/O interface 140.

According to an embodiment of the invention, the system program stored in the memory partition 126 can be utilized to update the application program stored in the memory partition 128 without the need to desolder the microcontroller chip. When the processor 110 executes the system program stored in the memory partition 126, the system program triggers the application program stored in the memory partition 128 to be updated, so as to change the operations of the processing device 100. This is called In-System Programming (ISP). For example, when the system program (such as the ISP program) is executed, the processor 110 may receive other application program from a host 200 (for example, a computer or an ISP tool) according to the default functions predefined by the system program, and may further store the new application program in the memory partition 128 to replace the original application program. This flow is a normal ISP procedure.

Generally, when the application program stored in the memory partition 128 is executed, the commands related to writing data into the memory partition 126 will be disabled. In other words, the processor 110 is usually not allowed to program the memory partition 126. Therefore, when the system program utilized to update the application program has to be changed or updated, desoldering of the microcontroller chip to re-burn new system program in the microcontroller chip is unavoidably required.

To solve this problem, in the embodiments of the invention, a novel method for changing the system program is proposed, such that the system program (for example, the ISP program) stored in the memory partition 126 can be changed or updated without desoldering of the microcontroller chip.

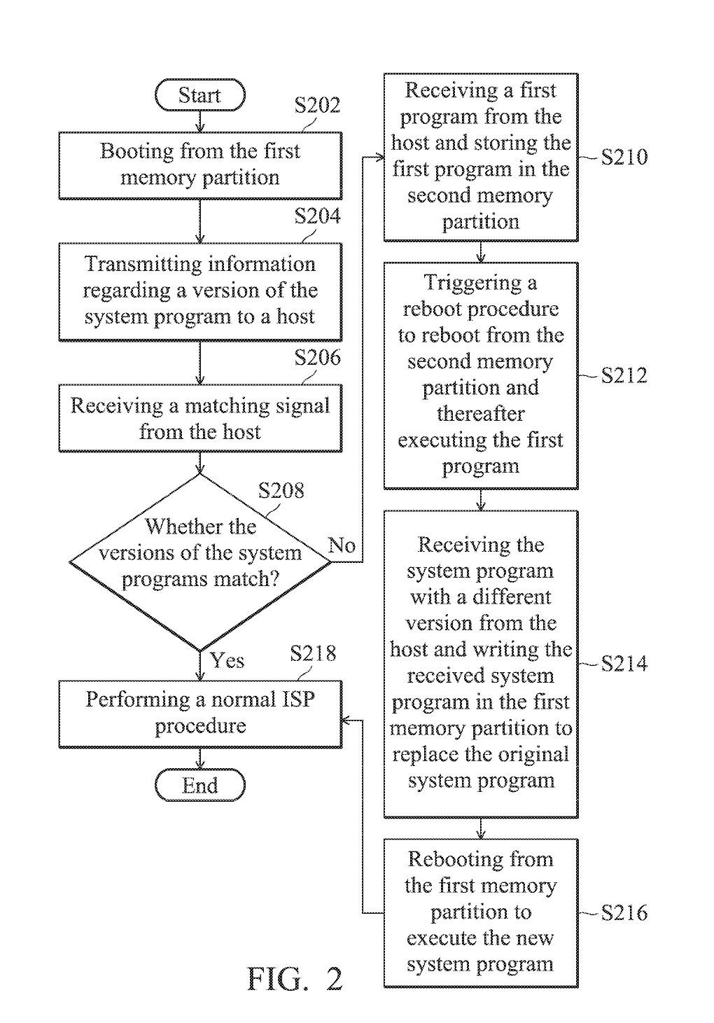

FIG. 2 shows a flow chart of a method for changing a system program according to a first embodiment of the invention. Note that the flow chart in FIG. 2 is described from the aspect of the processing device 100. First of all, when the processing device 100 is powered up, the processor 110 may boot from the first memory partition (Step S202) according to the hardware setting values in the memory device 130. For example, the processor 110 may read the booting sequence stored in the first memory partition to finish the booting step.

Next, in order to change the system program, the processor 110 may transmit information regarding a version of the system program (such as the ISP program) to the host via the I/O interface 140 (step S204). As discussed above, the host may be a computer or an ISP tool. Next, the processor 110 may receive a matching signal from the host (step S206). The matching signal may carry information regarding whether a version of the system program of the processing device 100 matches a version of the system program stored in the host. To be more specific, after receiving the information regarding a version of the system program from the processing device 100, the host may compare the version with that of the system program stored in the host to check whether they are the same, and then may carry the result in the matching signal to be transmitted to the processing device 100. Note that the system program stored in the host may be the latest version, a best version or a preferred version, or others.

After receiving the matching signal, the processor 110 may check whether the version of the system program stored in the processing device 100 matches that of the system program stored in the host (Step S208). When the version of the system program matches that of the system program stored in the host, the processor 110 may further perform a normal ISP procedure to update the application program (Step S218).

When the version of the system program does not match the version of the system program stored in the host, the processor 110 may further receive a first program from the host and store the first program in the second memory partition (Step S210). According to an embodiment of the invention, the first program can enable the processor 110 to program the first memory partition. Next, the processor 110 may trigger a reboot procedure through software to reboot from the second memory partition and thereafter execute the first program (Step S212). Note that since the reboot procedure is triggered by software, the processor 110 does not have to check the hardware setting values related to booting/rebooting in the memory device 130.

Next, the processor 110 may update the system program based on the first program. The processor 110 may further receive the system program with a different version from the host and may write the received system program into the first memory partition to replace the original system program (Step S214). According to an embodiment of the invention, the hardware setting values in the memory device 130 may be adequately designed such that when the first program is executed, the processor 110 is allowed to program the first memory partition. Note that those who are skilled in this art will readily appreciate that the way to allow the processor 110 to program the first memory partition when executing the program stored in the second memory partition is not limited to the methods as described above. For example, a monitor circuit or program may be designed to monitor the processor 110, and allow the processor 110 to program the first memory partition when the processor 110 executes the first program. Therefore, the invention should not be limited to any specific method of implementation.

When the system program are updated, the processor 110 may further trigger a reboot procedure via software to reboot from the first memory partition, execute the new system program (Step S216) and perform a normal ISP procedure according to the new system program.

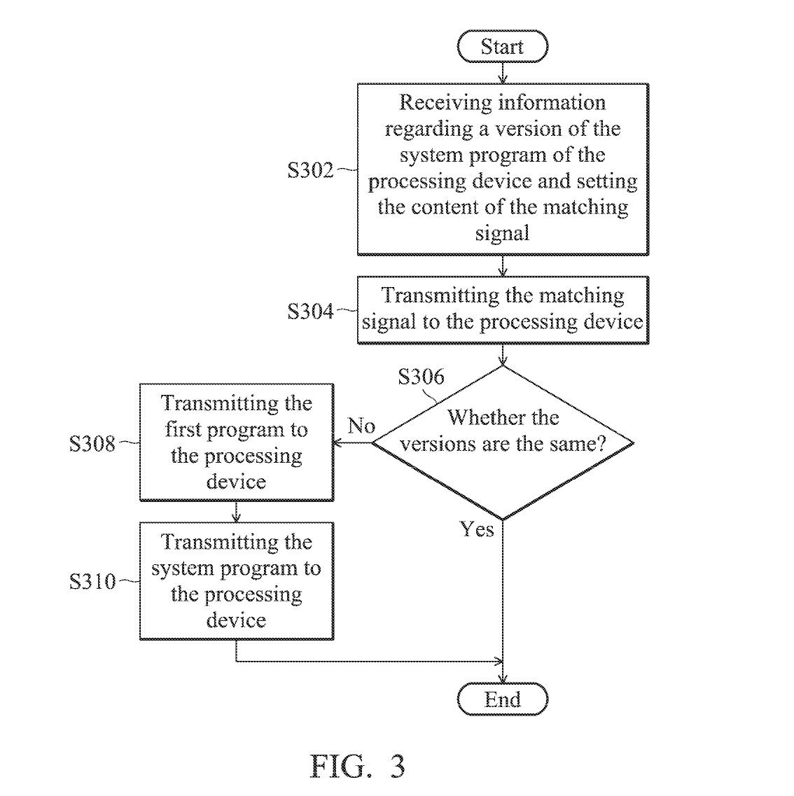

FIG. 3 shows a flow chart of another method for changing a system program according to a first embodiment of the invention. Note that the flow chart in FIG. 3 is described from the aspect of the host 200. First of all, corresponding to step S204 in FIG. 2, the host 200 may receive information regarding a version of the system program of the processing device 100 and set the content of the matching signal (step S302). After receiving information regarding the version of the system program, the host 200 may compare the version with that stored in the host to check whether the two versions are the same and set the content of the matching signal.

Next, the host 200 may transmit the matching signal to the processing device 100 (Step S304). Next, the host 200 may check whether the version of the system program stored in the processing device 100 is the same as the version of the system program stored in the host (Step S306). If yes, the host 200 will not execute the following update procedure. If not, the host 200 may transmit the first program to the processing device 100 (Step S308), which is corresponding to step S210 in FIG. 2. Next, corresponding to step S214 in FIG. 2, the host 200 may transmit the system program with a version different to that stored in the processing device 100 to the processing device 100 (Step S310) so as to enable the processing device 100 to change the system program stored therein based on the received system program. According to another embodiment of the invention, steps S304 and S306 may be merged. That is, the host 200 may determine whether the versions of the system program in the host and the processing device and transmit the matching signal to the processing device at the same time.

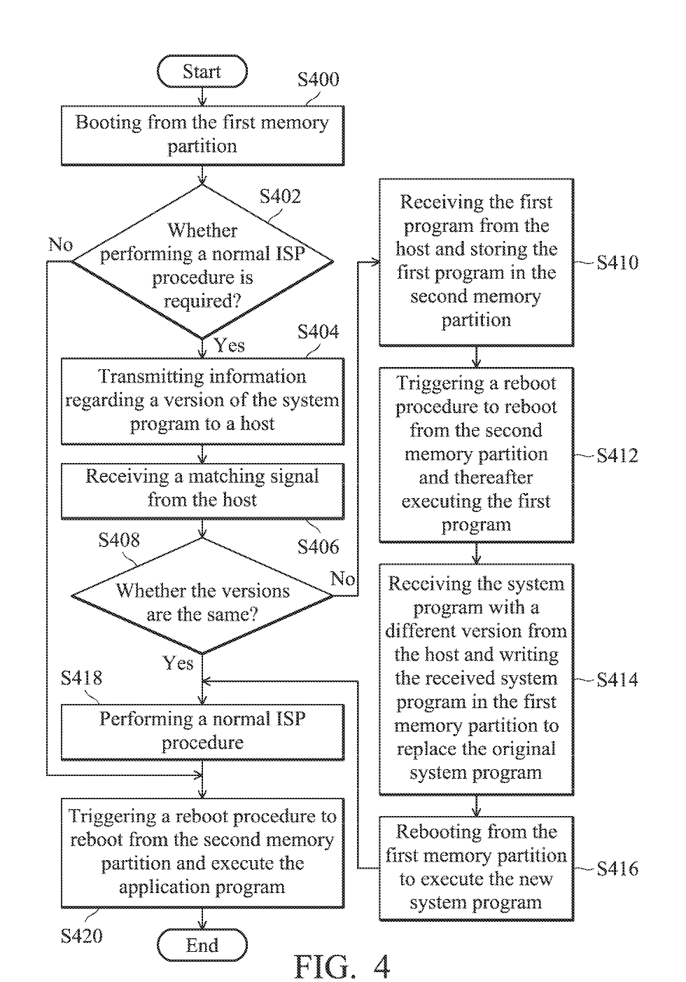

FIG. 4 shows a flow chart of a method for changing a system program according to a second embodiment of the invention. Note that the flow chart in FIG. 4 is described from the aspect of the processing device 100. In the second embodiment of the invention, the change of system program may be triggered before performing the normal ISP. First of all, when the processing device 100 is powered up, the processing device 100 may boot from the first memory partition according to the hardware setting values in the memory device 130 (Step S400). For example, the processor 110 may read the booting sequence stored in the first memory partition to finish the booting step.

Next, the processor 110 may determine whether performing a normal ISP procedure to update the application program stored in the second memory partition is required (S402). The processor 110 may determine whether performing the normal ISP procedure is required based on some signals or commands. For example, when the user wants to update the application program, the user may connect a host to the processing device 100. As discussed above, the host may be a computer or an ISP tool. When the I/O interface 140 has detected that there is any device connected to the processing device 100, the I/O interface 140 may issue a corresponding signal or command to the processor 110 to notify the processor 110.

When performing the normal ISP procedure is not required, the processor 110 may further trigger a reboot procedure via software to reboot from the second memory partition and execute the application program (Step S420). Therefore, the processor 110 may function as defined in the application program to provide the predetermined functions. When performing the normal ISP procedure is required, the processor 110 may transmit information regarding a version of the system program (for example, the ISP program) to a host via the I/O interface 140 (Step S404). Next, the processor 110 may receive a matching signal from the host (Step S406). The matching signal may carry information regarding whether a version of the system program of the processing device 100 is the same as that stored in the host.

After receiving the matching signal, the processor 110 may further check whether the versions are the same (Step S408). If yes, the processor 110 may perform the normal ISP procedure to update the application program (Step S418).

If the versions are different, the processor 110 may receive the first program from the host and store the first program in the second memory partition (Step S410). Next, the processor 110 may further trigger a reboot procedure via software to reboot from the second memory partition and thereafter execute the first program (Step S412).

Next, the processor 110 may change the system program based on the first program. The processor 110 may further receive the system program with a different version from the host and may write the received system program into the first memory partition to replace the original system program (Step S414).

When the system program is changed, the processor 110 may further trigger a reboot procedure via software to reboot from the first memory partition and execute the new system program (Step S416). Next, the processor 110 may perform a subsequent normal ISP procedure based on the new system program to update the application program (Step S418). Finally, the processor 110 may trigger a reboot procedure via software to reboot from the second memory partition and execute the application program. Therefore, the processor 110 may operate as defined in the application program to provide the predetermined functions.

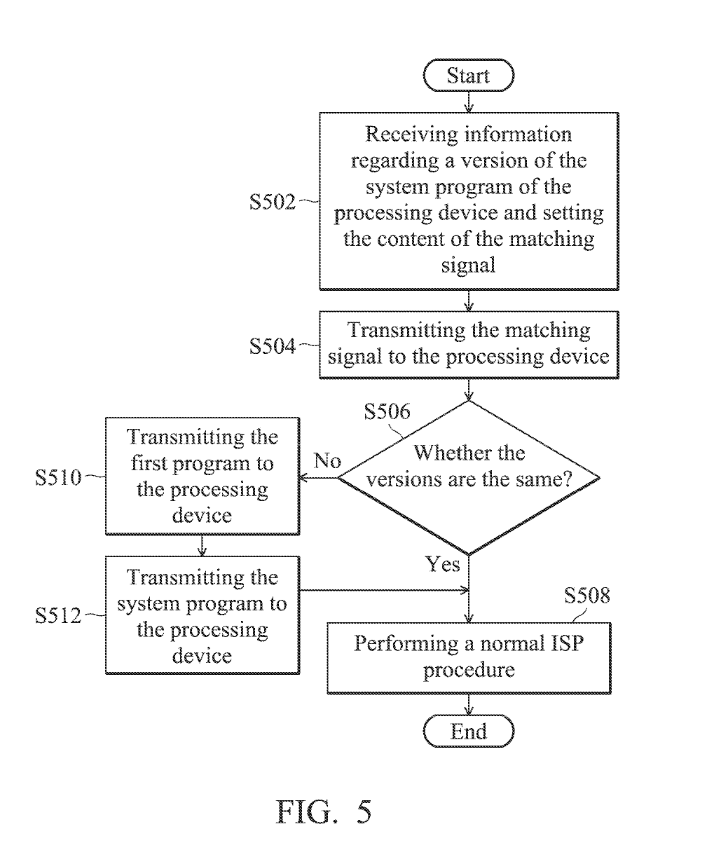

FIG. 5 shows a flow chart of another method for changing a system program according to a second embodiment of the invention. Note that the flow chart in FIG. 5 is described from the aspect of the host 200. First of all, corresponding to step S404 in FIG. 4, the host 200 may receive information regarding a version of the system program of the processing device 100 and set the content of the matching signal (Step S502). After receiving information regarding the version of the system program, the host 200 may compare the version with that stored in the host to check whether the two versions are the same and set the content of the matching signal.

Next, the host 200 may transmit the matching signal to the processing device (Step S504). Next, the host 200 may check whether the version of the system program stored in the processing device 100 is the same as the version of the system program stored in the host (Step S506). In another embodiment of the invention, steps S504 and S506 may be merged. If the same, the host 200 will not execute the following update procedure, but perform the normal ISP procedure (Step S508). For example, the host 200 may transmit another application program to the processing device 100 to trigger the processing device 100 to update the application program.

If not, the host 200 may transmit the first program to the processing device (Step S510), which is corresponding to step S410 in FIG. 4. Next, corresponding to step S414 in FIG. 4, the host 200 may transmit the system program with a different version to the processing device (Step S512) so as to enable the processing device to change the original system program based on the received system program. Finally, the host 200 may perform the ISP procedure (Step S508). For example, the host 200 may transmit another application program to the processing device 100 to trigger the processing device 100 to update the application program.

The above-described embodiments of the present invention can be implemented in any of numerous ways. For example, the embodiments may be implemented using hardware, software or a combination thereof. It should be appreciated that any component or collection of components that perform the functions described above can be generically considered as one or more processors that control the function discussed above. The one or more processors can be implemented in numerous ways, such as with dedicated hardware, or with general purpose hardware that is programmed using microcode or software to perform the functions recited above.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A processing device, comprising:
a program memory, comprising at least a first memory partition for storing a system program and a second memory partition for storing an application program; and
a processor, coupled to the program memory for executing the programs stored in the program memory, wherein the processor executes the application program to enable the processing device to provide at least a predetermined function, and executes the system program to enable the processing device to update the application program, and
wherein when the system program has to be changed, the processor further receives a first program from a host, stores the first program in the second memory partition, triggers a reboot procedure to reboot from the second memory partition and thereafter executes the first program, and changes the system program based on the first program.

2. The processing device as claimed in claim 1, wherein the system program stored in the first memory partition is the system program of a first version, and when executing the first program, the processor receives the system program of a second version from the host and writes the system program of the second version into the first memory partition to replace the system program of the first version.

3. The processing device as claimed in claim 2, wherein the processor further triggers a reboot procedure to reboot from the first memory partition and thereafter executes the system program of the second version so as to enable the processing device to update the application program based on the system program of the second version.

4. The processing device as claimed in claim 1, wherein the processor further receives a matching signal, the matching signal carries information regarding whether version of the system program stored in the program memory matches a version of a system program stored in the host, and when the version of the system program stored in the program memory does not match the version of the system program stored in the host, the system program has to be changed.

5. The processing device as claimed in claim 1, wherein when the application program is executed, the processor is not allowed to program the first memory partition of the program memory, and when the first program is executed, the processor is allowed to program the first memory partition of the program memory.

6. The processing device as claimed in claim 4, wherein when the version of the system program stored in the program memory matches the version of the system program stored in the host, the processor executes the system program to enable the processing device to update the application program.

7. The processing device as claimed in claim 1, wherein the processor further determines whether performing a normal In-System Programming (ISP) procedure is required, and when performing the normal ISP procedure is required, the processor further determines whether the system program has to be updated.

8. The processing device as claimed in claim 7, wherein performing the normal ISP procedure is not required, the processor further triggers a reboot procedure to reboot from the second memory partition and thereafter executes the application program.

9. A method for changing a system program, executed by a processor of a processing device for changing the system program stored in a first memory partition of a memory device of the processing device, wherein the processing device provides at least a predetermined function by executing an application program stored in a second memory partition of the memory device and the processing device updates the application program by executing the system program, the method comprising:
receiving a first program from a host;
the first program in the second memory partition of the memory device;
triggering a reboot procedure to reboot from the second memory partition; and
thereafter executing the first program to change the system program based on the first program, wherein the processor is allowed to program the first memory partition of the memory device by executing the first program.

10. The method as claimed in claim 9, wherein the system program stored in the first memory partition is the system program of a first version, and the method further comprises:
receiving the system program of a second version from the host; and
writing the system program of the second version in the first memory partition to replace the system program of the first version.

11. The method as claimed in claim 10, further comprising:
triggering a reboot procedure to reboot from the first memory partition; and
thereafter executing the system program of the second version to update the application program based on the system program of the second version.

12. The method claimed in claim 9, further comprising:
receiving a matching signal from the host, wherein the matching signal carries information regarding whether a version of the system program stored in the memory device matches a version of a system program stored in the host; and
when the version of the system program stored in the memory device does not match the version of the system program stored in the host, receiving the first program from the host.

13. The method claimed in claim 9, wherein when the application program stored in the second memory partition of the memory device is executed, the processor is not allowed to program the first memory partition of the memory device.

14. The method claimed in claim 9, further comprising:
determining whether performing a normal ISP procedure is required; and
receiving the first program from the host when performing the normal ISP procedure is required.

15. The method claimed in claim 9, further comprising:
executing the application program to enable the processing device to provide the predetermined function when performing the normal ISP procedure is not required.
